(19) United States
(12) Patent Application Publication
(10) Pub. No.: US 2025/0072522 A1
(43) Pub. Date: Mar. 6, 2025

(54) HEATING APPARATUS FOR AEROSOL-FORMING ARTICLES THAT MANAGES TEMPERATURE USING FREQUENCY INFORMATION

(71) Applicants: SILICON MITUS, INC., Seongnam-Si (KR); Hangzhou Silicon-Magic Semiconductor Technology Co., Ltd, Hangzhou City (CN)

(72) Inventors: Jun Ho Moon, Seongnam-Si (KR); Il Kwon Chang, Goyang-Si (KR)

(73) Assignees: SILICON MITUS, INC., Seongnam-Si (KR); Hangzhou Silicon-Magic Semiconductor Technology Co., Ltd, Hangzhou City (CN)

(21) Appl. No.: 18/815,541

(22) Filed: Aug. 26, 2024

(30) Foreign Application Priority Data
Aug. 31, 2023 (KR) 10-2023-0115644

(51) Int. Cl. A24F 40/57; A24F 40/20; A24F 40/465; A24F 40/51; A24F 40/53

(52) U.S. Cl. CPC A24F 40/57; A24F 40/465; A24F 40/51; A24F 40/53; A24F 40/20

(57) ABSTRACT

A heating apparatus for an aerosol-forming article includes: a housing that accommodates at least a portion of the aerosol-forming article; a power circuit that delivers power to a heat-generating body for heating the aerosol-forming article; a controller that controls the power circuit to adjust the heating temperature of the aerosol-forming article; a temperature sensor that detects the temperature of the housing and outputs an analog signal corresponding to the detected temperature; and an oscillator that outputs the signal of the frequency corresponding to the magnitude of the analog signal output by the temperature sensor; wherein the controller detects a user's puff or adjusts the heating temperature of the aerosol-forming article based on the frequency of the signal output by the oscillator.

### CROSS-REFERENCE TO RELATED APPLICATIONS

This application claims the benefit of Korea Patent Application No. 10-2023-0115644, filed on Aug. 31, 2023, which is incorporated herein by reference for all purposes as if fully set forth herein.

### TECHNICAL FIELD

The present disclosure relates to a heating apparatus for aerosol-forming articles. Specifically, the present disclosure relates to a heating apparatus for aerosol-forming articles using frequency information of an oscillator to manage the temperature of an aerosol-forming article.

### BACKGROUND

Conventionally, electronic devices that use aerosol-forming tobacco-containing articles to replace tobacco cigarettes are publicly known. These electronic cigarettes use devices to heat aerosol-forming articles.

One conventional method for heating aerosol-forming articles relates to a resistive heating method in which a metal heat-generating body installed in a housing generates resistive heating and the metal heat-generating body contacts an aerosol-forming article to heat the aerosol-forming article until it reaches a temperature at which volatile compounds are released. According to the resistive heating method, the metal heat-generating body may be implemented to have various shapes, such as heating blades, heating spears, and heating cans. This method is often referred to as a contact type since the heat-generating body is mainly installed in a housing and is directly connected to a power circuit through wiring to receive power.

Another conventional method for a heating apparatus for an aerosol-forming article relates to an electromagnetic induction that utilizes the heat generation characteristics by generating eddy currents to prevent power loss in a metal heat-generating body. In the electromagnetic induction heating method, a power circuit uses an LC-type resonant network containing an inductor to generate an alternating magnetic field and the alternating magnetic field generates eddy currents in a metal heat-generating body raising the temperature of the metal heat-generating body. The aerosol-forming article in contact with the heat-generating body is heated to a temperature at which volatile compounds are released. This method is often referred to as a non-contact type in a way that it is not directly connected to a power circuit through wiring.

The temperature of an aerosol-forming article needs to be detected and managed both in contact and non-contact types described above. In both methods, the temperature of aerosol-forming articles is very high (usually approximately 200° C. or higher). In this case, a temperature sensor is not only expensive, but also has a slow response speed. Unfortunately, a high-resolution Analog-Digital (AD) converter is required in order for a digital controller such as a Micro Controller Unit (MCU) to use temperature information since the output of temperature information detected by a temperature sensor is indicated in a form of an analog signal.

Furthermore, in the non-contact type, a heat-generating body is often installed inside an aerosol-forming article but cannot be physically connected to a controller inside a housing through wiring. Thus, it is difficult to transmit the detected temperature information to a controller inside a housing even if a temperature of a heat-generating body is detected. In other words, in a non-contact type, it is difficult to directly detect a temperature of a heat-generating body or aerosol-forming article.

Conventionally, the value of the apparent ohmic resistance is calculated by using the relationship between the direct-current voltage and currents that are supplied from a power circuit to a heat-generating body and then the temperature of a heat-generating body is estimated based on the value of the apparent ohmic resistance. However, it may raise a question concerning the reliability of the apparent ohmic resistance value as the positional relationship between an inductor that generates the magnetic field and a heat-generating body that is inductively heated may change. In addition, in order to calculate the apparent ohmic resistance value, it is necessary to detect the direct current supplied from a power circuit to a heat-generating body, which not only causes losses but also increases the complexity of system implementation.

### SUMMARY

In accordance with one or more embodiments of the present disclosure, the temperature is effectively managed by using a simple structure of a heat-generating body for an aerosol-forming article.

In accordance with one or more embodiments of the present disclosure, puffs are effectively detected by using a simple structure of a heat-generating body for an aerosol-forming article.

The embodiments according to the concept of the present disclosure may be embodied in various forms and should not be construed as limited to the embodiments set forth herein. Rather, various forms of embodiments may be included in this specification.

In one aspect of the disclosure, a heating apparatus for an aerosol-forming article includes a housing that accommodates at least a portion of an aerosol-forming article; a power circuit that delivers electrical power to a heat-generating body for heating the aerosol-forming article; a controller that controls the power circuit to adjust a heating temperature of the aerosol-forming article; a temperature sensor that detects the temperature of the housing and outputs an analog signal corresponding to the detected temperature; and an oscillator that outputs a frequency signal corresponding to a magnitude of the analog signal output by the temperature sensor; wherein the controller detects a user's puff or adjusts the heating temperature of the aerosol-forming article based on the frequency signal output by the oscillator.

In one or more embodiments, the heating apparatus is a contact type where the heat-generating body is installed in the housing; a maximum heating temperature of the aerosol-forming article is 200° C. or higher; and the temperature sensor is a thermistor which is installed in the housing to detect the temperature of the housing.

In one or more embodiments, the heat-generating body is inserted into the aerosol-forming article; the heating apparatus is a non-contact type that heats the heat-generating body in an inductively coupled manner; and the temperature sensor is a thermistor which is installed in the housing to detect the temperature of the housing.

In one or more embodiments, even if a change in the analog signal output by the temperature sensor due to puffs falls between as small as 10 mV and 20 mV, the controller can detect a puff.

In one or more embodiments, the maximum temperature detected by the thermistor may be 130° C. or less.

In one or more embodiments, the controller can detect the frequency of the signal output by the heat-generating body using a clock counter.

In one or more embodiments, the oscillator may be a voltage-controlled oscillator that outputs the signal of the frequency corresponding to the voltage magnitude of the analog signal output by the temperature sensor.

In accordance with one or more embodiments of the present disclosure, a temperature can be effectively managed by using a simple structure of a heating apparatus for aerosol-forming articles.

In accordance with one or more embodiments of the present disclosure, a puff can be detected by using a simple structure of a heating apparatus for aerosol-forming articles.

The effects of the present disclosure are not limited to the effects described above, and various effects not mentioned herein may be included in the present specification.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a general structure of a heating apparatus for aerosol-forming articles.

FIG. 2 illustrates a contact type heating apparatus with a heat-generating body installed in a housing.

FIG. 3 illustrates a contact type heating apparatus with an aerosol-forming article inserted into a heating apparatus.

FIG. 4 illustrates a non-contact type heating apparatus in which a heat-generating body is inserted into an aerosol-forming article.

FIG. 5 illustrates a contact type heating apparatus in accordance with one or more embodiments of the present disclosure.

FIG. 6 illustrates a non-contact type heating apparatus in accordance with one or more embodiments of the present disclosure.

FIGS. 7A-7C illustrate a temperature of a housing, the output voltage of a thermistor, and the frequency waveforms during a puff.

### DETAILED DESCRIPTION

Hereinafter, some embodiments of the present disclosure will be described with reference to exemplary drawings. It should be noted that, in adding reference numerals to the constituent elements of the drawings, the same constituent elements are denoted by the corresponding reference symbols even if they are shown in different drawings. In addition, in describing the present disclosure, a detailed description of known functions and configurations incorporated herein will be omitted when it may make the subject matter of the present disclosure rather unclear.

In describing the constituent elements of the present disclosure, the terms A, B, (a), (b), and the like can be used. These terms are intended to distinguish the constituent elements from other constituent elements, and the terms do not limit the nature, order or order of the constituent elements. When a component is described as being “connected”, “comprising”, or “configured” to another component, the component may be directly connected or connected to the other component, it is to be understood that the element may be “connected”, “comprising”, or “configured”.

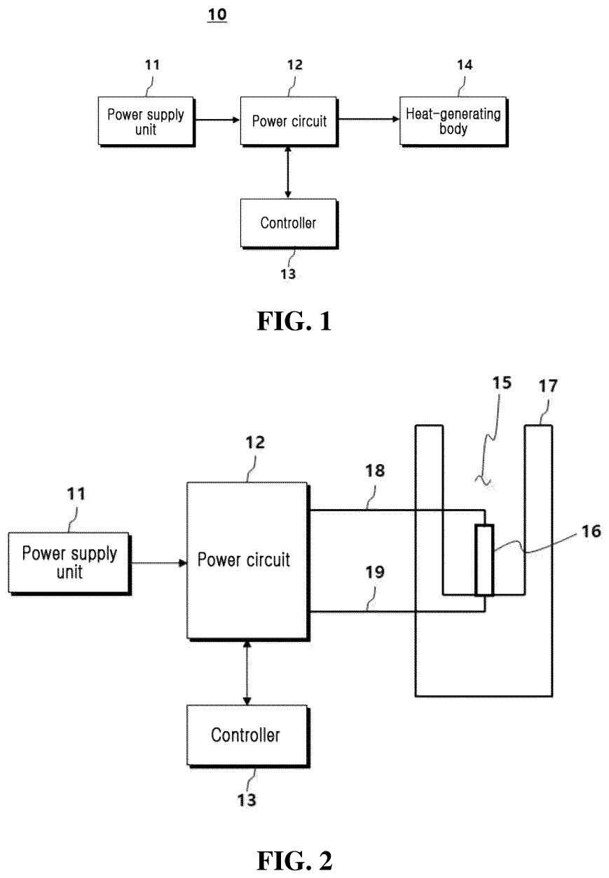

FIG. 1 illustrates a general structure of a heating apparatus for aerosol-forming articles.

A heating apparatus for aerosol-forming articles 10 may be a device for heating the aerosol-forming article to generate an aerosol from the aerosol-forming article. In one or more embodiments, a heating apparatus for aerosol-forming articles 10 may be a device for electronic cigarettes.

Referring to FIG. 1, a heating apparatus for aerosol-forming articles 10 may include a power supply unit 11, power circuit 12, controller 13 and heat-generating body 14.

A power supply unit 11 may supply power to a power circuit 12 and controller 13. In one or more embodiments, a power supply unit 11 may include a rechargeable battery.

A power circuit 12 may transfer power supplied by the power supply unit 11 to the heat-generating body 14. In one or more embodiments, a power circuit 12 may receive DC power from a power supply unit 11 and then convert it into direct current, alternating current, or other forms of power to be supplied to a heat-generating body 14. A power circuit 12 may be implemented in various forms depending on the type and structure of a heat-generating body 14. Since any known technique may be used for a power circuit 12, detailed description thereof will be omitted.

The heat-generating body 14 is a configuration that receives power from a power circuit 12 and generates heat to heat the aerosol-forming article. It can be implemented in various forms.

A heat-generating body 14 may be a resistive heat-generating body. In one or more embodiments, when currents are supplied to a heat-generating body 14, the heat that is proportional to the square of the current magnitude may be generated. A resistive heat-generating body may be implemented to have various forms such as heating blades, heating shears, and heating cans. When a heat-generating body 14 is a resistive metal heat-generating body, a power circuit 12 may include a circuit capable of adjusting the magnitude of the current while supplying DC to a heat-generating body 14.

In one or more embodiments, a heat-generating body 14 may have a configuration in which heat is generated by eddy currents depending on changes in the magnetic field. In this case, a heat-generating body 14 may generate heat by an alternating magnetic field generated by a power circuit 12 without being physically connected to a power circuit 12 through wiring. In one or more embodiments, a power circuit 12 uses an LC-type resonant network containing an inductor to generate an alternating magnetic field by allowing an alternating current to flow through an inductor, and a heat-generating body 14 which is implemented in the form of a metal rod inserted into the aerosol-forming article may generate heat due to the alternating magnetic field.

When a heat-generating body 14 is a resistive heat-generating body, a heat-generating body is typically installed in a housing and directly, physically connected to a power circuit 12 through wiring. This method will be referred to as a contact type. Whereas a heat-generating body 14 generates heat by an alternating magnetic field, a heat-generating body 14 is not directly, physically connected to a power circuit 12, but is used by inserting it into an aerosol-forming article. This method will be referred to as a non-contact type.

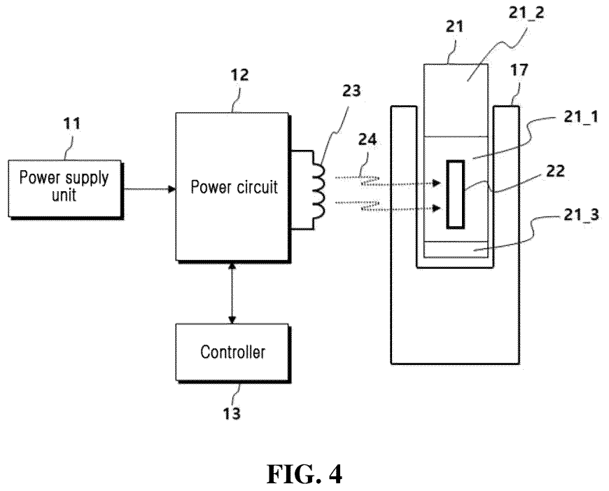

In FIG. 1, a heat-generating body 14 is illustrated as part of a heating apparatus 10, but depending on the structure or type of a heat-generating body, a heat-generating body may be a component external to a heating apparatus 10. In one or more embodiments, in the case of a contact heat-generating body (see FIG. 2), it is reasonable to view the heat-generating body as a component of the heating apparatus, but in the case of a con-contact type where the heat-generating body is inserted inside an aerosol-forming article rather than installed in a housing (see FIG. 4), it may be reasonable to consider a heat-generating body 14 as not part of a heating apparatus 10.

A controller 13 can control a power circuit 12 to adjust a heating temperature of an aerosol-forming article. A heating temperature adjustment of an aerosol-forming article may be understood as a concept which includes the temperature adjustment of a heat-generating body 14 in that a heating temperature of an aerosol-forming article can be adjusted by controlling the temperature of a heat-generating body 14.

The method by which a controller 13 controls a power circuit 12 may vary depending on the type of a heat-generating body 14 and the type of a power circuit 12. Since the control method of a controller 13 according to a heat-generating body 14 and a power circuit 12 can use known technologies, detailed description thereof will be omitted in this specification.

FIG. 2 illustrates a contact heating apparatus with a heat-generating body installed in a housing.

Referring to FIG. 2, a heating apparatus includes a housing 17, and a heat-generating body 16 can be installed in a housing 17. In one or more embodiments, there is a space 15 inside a housing into which an aerosol-forming article is inserted and a heat-generating body 16 can be installed to be fixed to a housing 17. In one or more embodiments, a heat-generating body 16 is formed to be protruded toward the inner space 15 of a housing 17 and contacts the aerosol-forming article inserted into the inner space 15 of the housing. A heat-generating body 16 can be physically connected to a power circuit 12 through wiring 18, 19 to receive power from a power circuit 12.

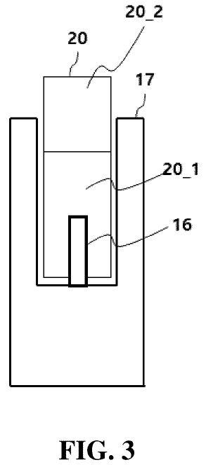

FIG. 3 illustrates a contact heating apparatus with at least a portion of an aerosol-forming article 20 inserted into a housing 17. In one or more embodiments, when an aerosol-forming article 20 is a stick for an electronic cigarette, an aerosol-forming article 20 may include an aerosol generator 20_1 and a filter 20_2. A heat-generating body 16 is installed in a housing 17 and is formed to protrude toward the inner space of a housing 17 (reference numeral 15 in FIG. 2) so that when an aerosol-forming article 20 is inserted into the inner space of a housing 17, a heat-generating body 16 can heat an aerosol generator 20_1 as a heat-generating body 16 is inserted into an aerosol generator 20_1.

FIG. 4 illustrates a non-contact heating apparatus in which a heat-generating body 22 is inserted into an aerosol-forming article 21.

Referring to FIG. 4, an aerosol-forming article 21 may include an aerosol generator 21_1, a filter 21_2, and a closing part 21_3. A heat generating body 22 may be inserted into an aerosol generator 21_1.

In this case, a power circuit 12 is implemented as a coil or the like and may include an inductor 23 which generates a magnetic field. A power circuit 12 can generate an alternating magnetic field 24 by passing alternating currents through an inductor 23. An alternating magnetic field 24 can heat a heat-generating body 22 by forming eddy currents in a heat-generating body 22. Since a heat-generating body 22 is inserted into an aerosol generator 21_1, an aerosol generator 21_1 can be heated by a heat-generating body 22.

In the method of using a magnetic field, a heat-generating body 22 does not necessarily have to be placed inside an aerosol-forming article 21, but when a heat-generating body 22 is placed inside an aerosol-forming article 21, it is advantages such soot and odor of an heat-generating body 22 will be reduced as a heat-generating body 22 is not exposed to the outside.

Although a generally used heating apparatus for aerosol-forming articles has been described in one or more embodiments, it should be understood that a heating apparatus for aerosol-forming articles described herein is not limited to such structure.

In addition, in FIGS. 2 and 4, a power supply unit 11, power circuit 12, and controller 13 are shown as being arranged outside a housing 17 for convenience of explanation; however, it would be more common for these configurations to be disposed inside a housing 17.

The temperature management of contact or non-contact methods mentioned above will be described thereafter.

First, in temperature management of the contact type with reference to one or more embodiments disclosed in FIG. 2, high temperatures of a heat-generating body 16 may cause difficulty in temperature management.

Thermistors, resistive temperature detectors, or thermocouples are mainly used as temperature sensors among which thermistors have the advantage of being the cheapest and having a fast response time, but usually they can operate normally only at temperatures below 130° C. For electronic cigarettes, a heating temperature of an aerosol-forming article is generally targeted at 200° C. or higher. Therefore, it is difficult to use a thermistor that has a low price and a fast response time.

Since a resistive temperature detector and a thermocouple can be used even at high temperature conditions, they can be used in a heating apparatus for aerosol-forming articles in terms of the maximum temperature, but unfortunately they have a slow response time for detecting temperatures. The slow response time in detecting a temperature causes performance deterioration of the temperature control, especially in detecting a user's puff. In order to detect a puff, temperature changes even within several hundred ms must be detected accurately. In this sense, a resistive temperature detector or thermocouple that can operate at high temperature may not be suitable for use in detecting a puff due to their slow response time.

Therefore, in order to detect the temperature of a heat-generating body or an aerosol-forming article in a heating apparatus for aerosol-forming articles, there is room for improvement in that a temperature sensor that can operate at a high temperature of 200° C. or higher and has a fast response time is required.

In addition, most of the output of temperature sensors is the analog voltage signal while controllers are implemented as a digital device such as a MCU. Therefore, an AD converter is required to transmit the analog information detected by a temperature sensor to a digital controller. A high-resolution AD converter is required in order for a controller to utilize the detected subtle changes in temperature information, and this may result in increasing manufacturing costs.

In addition, in the case of a non-contact heating apparatus depicted in FIG. 4, there are additional problems on top of those of a contact heating apparatus described above.

In the case of a contact heating apparatus depicted in FIG. 2, since a heat-generating body 16 is installed in a housing 17, the output signal of a temperature sensor that detects the temperature of a heat-generating body 16 can be directly transmitted to a controller 13 through wiring. In the case of a non-contact heating apparatus depicted in FIG. 4, on the other hand, both a heat-generating body 22 and an aerosol-forming article 21 are spatially separated from a housing 17. As a result, even if a temperature sensor is installed on the side of an aerosol-forming article 21 to detect the temperature of a heat-generating body 22 or aerosol-forming article, it is difficult to transmit that output signal to a controller 13. It is not practical to equip each of an aerosol-forming article 21 with a wireless communication means to transmit temperature information.

As described above, a method using the apparent ohmic resistance value was provided. However, in this method, the apparent ohmic resistance value may change due to changes in spatial position between an inductor that generates the magnetic field and a heat-generating body that is inductively heated. Furthermore, in order to calculate the apparent ohmic resistance value, direct currents supplied to a heat-generating body must be detected, which not only causes losses but also increases the complexity of the system implement. Since most heating apparatuses for electronic cigarettes are powered by batteries whose sizes tend to be getting smaller, it is difficult to use batteries that have a higher capacity. It is necessary to minimize power consumption as a user is rather interested in how many sticks can be used per each charge. Thus, having to detect direct currents can be a significant burden from a design perspective.

One or more embodiments of the present disclosure relate to temperature management in a heating apparatus for aerosol-forming articles.

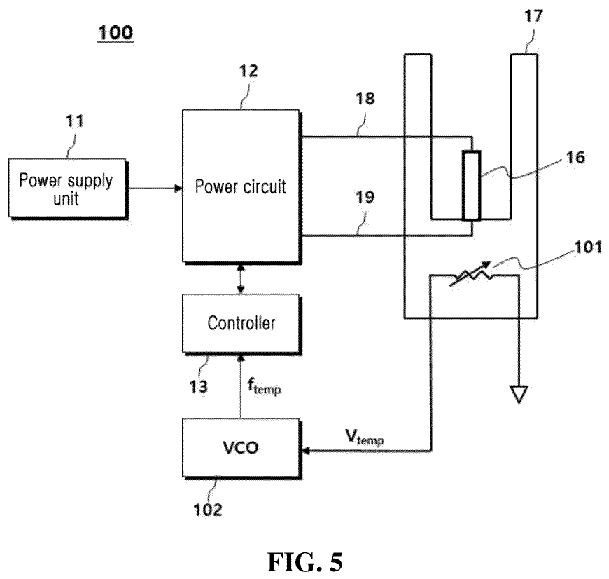

FIG. 5 illustrates a contact heating apparatus in accordance with one or more embodiments of the present disclosure.

Referring to FIG. 5, a heating apparatus 100 may include a power supply unit 11, power circuit 12, controller 13, heat-generating body 16, housing 17, and temperature sensor 101, and oscillator 102.

A power supply unit 11 can supply power to a power circuit 12 and a controller 13. In one or more embodiments, a power supply unit 11 may include a rechargeable battery.

A power circuit 12 can deliver power to a heat-generating body 16 that heats aerosol-forming articles. A power circuit 12 may be implemented in various forms depending on the type or structure of a heat-generating body 16.

A controller 13 may control a power circuit 12 to adjust the heating temperature of an aerosol-forming article. The method by which a controller 13 controls a power circuit 12 may vary depending on the type of a heat-generating body 16 and power circuit 12.

A heat-generating body 16 is a component that generates heat by receiving power and can be implemented in various forms. The maximum heating temperature of an aerosol-forming article may reach 200° C. or higher.

FIG. 5 illustrates a contact type where a heat-generating body 16 is installed in a housing 17. In this case, a heat-generating body 16 can be physically connected through wiring 18, 19 to a power circuit 12 to receive power directly.

A housing 17 may accommodate at least a portion of an aerosol-forming article. A heat-generating body 16 can be fixedly installed on a housing 17.

The above description with reference to FIG. 1 or 4 may be applied to a power supply unit 11, power circuit 12, controller 13, heat-generating body 16, and housing 17.

A temperature sensor 101 can detect the temperature of a housing 17 and output an analog signal corresponding to the detected temperature. Even if the maximum temperature of an aerosol-forming article is 200° C. or higher, the temperature of a housing 17 can be lower than that. In accordance with one or more embodiments a thermistor that has a low price and fast response time may be used for a temperature sensor 101. In one or more embodiments, when the maximum heating temperature of an aerosol-forming article is 200° C. or higher, the temperature of an aerosol-forming article can be managed using a thermistor with a maximum detection temperature of 130° C. or less according to this embodiment.

A temperature sensor 101 may detect the temperature of the housing 17 at different positions. In one or more embodiments, the temperature sensor 101 may detect the temperature on the surface or inside the housing 17. When a thermistor is used for a temperature sensor 101, in one or more embodiments, a NTC (Negative Temperature Coefficient) thermistor may be used.

The signal output by a temperature sensor 101 may be an analog signal. The analog signal output by a temperature sensor 101 may mainly be in the form of voltage or current, but is not limited thereto.

An oscillator 102 may output the frequency signal corresponding to the magnitude of the analog signal output by a temperature sensor 101. In one or more embodiments, as illustrated in FIG. 5, when a temperature sensor 101 outputs an analog voltage signal (Vtemp) corresponding to the temperature, an oscillator 102 is implemented as a voltage-controlled oscillator (VCO) and can output the signal with the frequency (ftemp) corresponding to the magnitude of the analog voltage signal output by a temperature sensor 101.

A controller 13 can receive the signal (ftemp) output by an oscillator 102. A controller 13 may detect a puff or adjust the heating temperature of an aerosol-forming article based on the frequency signal (ftemp) output by an oscillator 102. A digital controller such as a MCU may be used as a controller 13. A controller 13 may include a clock counter to extract frequency information from the signal (ftemp) output by an oscillator 102. According to the described embodiments, an oscillator 102 and a controller 13 may be implemented on a single silicon chip or in the form of a single package to be made compact.

According to one or more embodiments, a temperature sensor 101 does not detect the temperature of a heat-generating body 16 or aerosol-forming article, but rather detects the temperature of a housing 17. Since a housing 17 closely surrounds an aerosol generator (20_1 of FIG. 3 and 21_1 of FIG. 4) of the aerosol-forming article, there is a close correlation between the temperature of an aerosol-forming article and the temperature of a housing 17. Therefore, it may be very effective to manage the temperature of an aerosol-forming article using the temperature information of a housing 17.

In addition, since the temperature of a housing 17 is significantly lower than that of a heat-generating body 16 or aerosol-forming article, when a temperature sensor 101 detects the temperature of a housing 17, it has advantage of being able to use a thermistor that cannot operate at high temperature conditions. In one or more embodiments, a thermistor with the maximum operating temperature of 130° C. or less can be used even if the maximum heating temperature of an aerosol-forming article is 200° C. or higher. Using a thermistor is not only cheaper but is also able to improve accuracy of detecting a puff and a control speed of a controller by using fast response time.

In addition, according to one or more embodiments, rather than transmitting the analog signal output (Vtemp) by a temperature sensor 101 to a controller 13 using an AD converter, it is converted into frequency information using an oscillator 102, and a controller 13 uses a clock counter to extract frequency information from the signal (ftemp) output by an oscillator 102, making it able to obtain temperature information provided by a temperature sensor 101. Since an oscillator 102 and clock counter can be implemented easily and cheaply, it can save costs compared to using an AD converter. In particular, an oscillator 102 and clock counter can be implemented on one silicon chip with a controller implemented as a MCU, etc. or in one package. In this case, its size can be further miniaturized, and its manufacturing cost can be reduced.

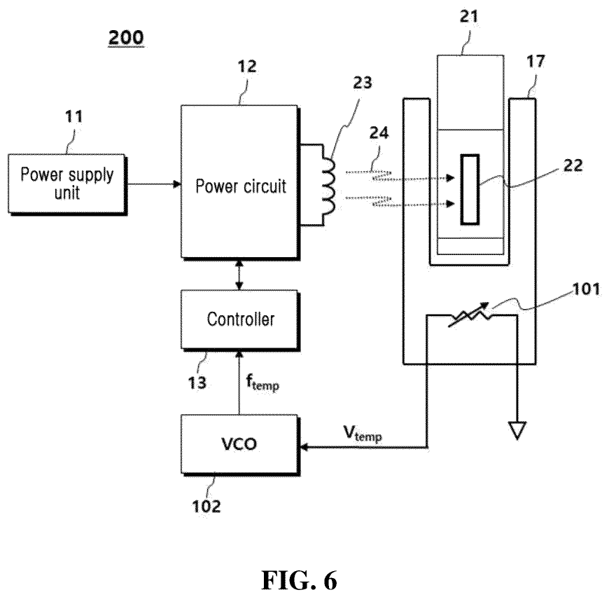

FIG. 6 illustrates a non-contact heating apparatus in accordance with one or more embodiments of the present disclosure.

Referring to FIG. 6, a heating apparatus may include a power supply unit 11, power circuit 12, controller 13, housing 17, temperature sensor 101 and oscillator 102. Although a heat-generating body 22 is a component necessary for a heating function of a heating apparatus 200, there may be a view that it is not considered a component of a heating apparatus 200 as it is inserted into an aerosol-forming article 21.

The arrangement described with reference to FIGS. 4 and 5 may be equally applied to a power supply unit 11, a power circuit 12, a controller 13, a housing 17, a temperature sensor 101 and an oscillator 102, as long as they do not contradict what will be explained below.

In a non-contact heating apparatus 200, a power circuit 12 may include an inductor 23 to generate a magnetic field. Transmitting alternating currents to an inductor 23 in a power circuit 12 can produce the alternating magnetic field 24 by an inductor 23. The alternating magnetic field 24 created by an inductor 23 can create eddy currents in a heat-generating body 22. Eddy currents created in a heat-generating body 22 can increase the temperature of a heat-generating body 22.

In one or more embodiments illustrated in FIG. 6, a heat-generating body 22 is inserted into an aerosol-forming article 21 and a heating apparatus 200 may be a non-contact type to heat a heat-generating body 22 in an inductively coupled manner. Here, a temperature sensor 101 may detect the temperature of a housing 17 rather than detecting the temperature of a heat-generating body 22 or aerosol-forming article 21. Since the temperature of a housing 17 is significantly lower than that of a heat-generating body 22 or aerosol-forming article 21, a thermistor can be used as a temperature sensor 101.

In the case of non-contact as illustrated in FIG. 6, it is difficult to directly detect the temperature of a heat-generating body 22 or aerosol-forming article 21 as a heat-generating body 22 is implemented inside the aerosol-forming article 21. According to one or more embodiments, it has an advantage of eliminating the need to directly detect the temperature of a heat-generating body 22 or aerosol-forming article 21 by detecting the temperature of a housing 17 to be used in temperature management of an aerosol-forming article 21.

In the case of the technology that calculates the apparent ohmic resistance value using the relationship between current and direct current voltage supplied to a heat-generating body and estimates the temperature of a heat-generating body based on the value of apparent ohmic resistance, which is presented as one of non-contact temperature management methods, the apparent ohmic resistance value may fluctuate due to a position deviation between an inductor that creates the magnetic field and an inductively coupled heat-generating body, which may result in a decrease in the accuracy of temperature management. However, according to one or more embodiments, there is an advantage of being able to implement non-contact temperature management without using the apparent ohmic resistance value. Furthermore, while it is necessary to detect the direct current supplied to a heat-generating body in order to calculate the apparent ohmic resistance value, there is an advantage of being able to simplify the system configuration and reduce power losses in that there is no need to detect the direct current according to this embodiment.

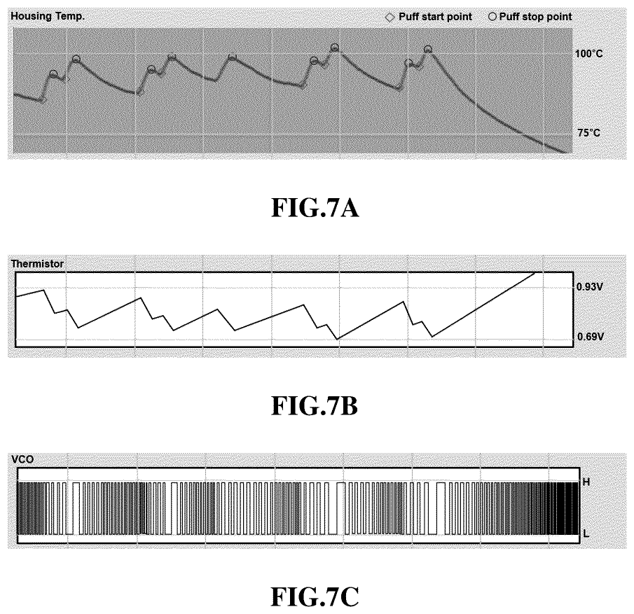

FIGS. 7A-7C illustrate changes in the housing temperature, frequency and output voltage of a thermistor due to a puff. FIG. 7A depicts a housing temperature; FIG. 7B depicts output voltage of a thermistor; and FIG. 7C depicts the output waveform of an oscillator.

When a puff is performed, an aerosol heated by a heat-generating body increases the temperature of a housing. In FIG. 7A, the square marker indicates the point at which a puff starts (the point at which the temperature rises), and the circle marker indicates the point at which a puff ends (the point at which the temperature rise ends). When a temperature sensor is implemented as a NTC (Negative Temperature Coefficient) thermistor, the output voltage of a temperature sensor decreases as the temperature of a housing increases. FIG. 7B illustrates changes in output voltage of a temperature sensor based on changes in temperature of a housing in FIG. 7A. An oscillator can output the signal in the form of a square wave whose frequency varies depending on the output voltage of a temperature sensor, which is illustrated in FIG. 7C.

According to one or more embodiments of the present disclosure, since temperature information and puffs are detected by using the changes in the frequency of an oscillator, a controller can still detect a user's puff when the range of the change in the magnitude of the analog signal output by a temperature sensor due to a puff is as small as 10 mV and 20 mV. In the case of a method using an AD converter, the advantage of the present embodiments can be clearly understood in that a high-resolution AD converter is required to detect a puff from such changes in voltage levels.

As exemplarily explained with reference to the drawings above, according to one or more embodiments, it has the advantage of eliminating the need to directly detect the temperature of a heat-generating body or aerosol-forming article by detecting the temperature of a housing and using it to manage the temperature of an aerosol-forming article. Eliminating the need to directly detect the temperature of a heat-generating body or aerosol-forming article means that the difficulty in transferring temperature information in a non-contact induction heating is eliminated. Furthermore, the method of detecting the temperature of a housing can not only increase the accuracy of puff detection and control speed of a controller by using a thermistor's fast response time but also reduce manufacturing costs by allowing the use of a thermistor that cannot operate at high temperatures both in contact and non-contact conditions.

In addition, according to one or more embodiments, rather than transmitting the analog signal output by a temperature sensor to a controller using an AD converter, an oscillator is used to convert it into frequency information and a controller can obtain temperature information provided by a temperature sensor by using a clock counter to extract frequency information from the signal output by an oscillator. Since an oscillator and clock counter can be implemented simply and inexpensively, a simple structure can be provided, and costs can be decreased compared to adding a separate high-resolution AD converter.

Terms such as “include,” “comprise,” or “have” herein mean that the corresponding components may be included, unless specifically stated to the contrary, and thus do not exclude other components. Rather, it should be interpreted as being able to include other components. All terms, including technical and scientific, unless otherwise defined, have the same meaning as generally understood by a person of ordinary skill in the technical field to which the present invention pertains. Commonly used terms, such as terms defined in a dictionary, should be interpreted as consistent with the meaning in the context of the related technology, and should not be interpreted in an idealized or overly formal sense unless explicitly defined in the present invention.

The above description is merely illustrative of the technical idea of the present disclosure, and those of ordinary skill in the technical field to which the present disclosure belongs will be able to make various modifications and variations without departing from the essential characteristics of the present disclosure. Accordingly, embodiments herein are not intended to limit the technical idea of the present disclosure, but to explain the technical idea, and the scope of the technical idea of the present disclosure is not limited by these embodiments. The scope of protection of this disclosure should be interpreted by the following claims, and all technical ideas within the scope equivalent thereto should be construed as being included in the scope of the present disclosure.

### DESCRIPTION OF REFERENCE SIGNS

11: Power supply unit
12: Power circuit
13: Controller
14: Heat-generating body

What is claimed is:

1. A heating apparatus for an aerosol-forming article, comprising:
a housing that accommodates at least a portion of the aerosol-forming article;
a power circuit that delivers power to a heat-generating body for heating the aerosol-forming article;
a controller that controls the power circuit to adjust a heating temperature of the aerosol-forming article;
a temperature sensor that detects the temperature of the housing and outputs an analog signal corresponding to the detected temperature; and
an oscillator that outputs a frequency signal corresponding to a magnitude of the analog signal output by the temperature sensor;
wherein the controller detects a user's puff or adjusts the heating temperature of the aerosol-forming article based on the frequency signal output by the oscillator.

2. The heating apparatus for the aerosol-forming article of claim 1,
wherein the heating apparatus is a contact type where the heat-generating body is installed in the housing,
a maximum heating temperature of the aerosol-forming article is 200° C. or higher, and
the temperature sensor is a thermistor and is installed in the housing to detect the temperature of the housing.

3. The heating apparatus for the aerosol-forming article of claim 1, wherein
the heat-generating body is inserted into the aerosol-forming article,
the heating apparatus is a non-contact type that heats the heat-generating body in an inductively coupled manner, and
the temperature sensor is a thermistor and is installed in the housing to detect the temperature of the housing.

4. The heating apparatus for the aerosol-forming article of claim 2, wherein
even if a change in the analog signal output by the temperature sensor due to a user's puff falls between as small as 10 mV and 20 mV, the controller can detect a puff.

5. The heating apparatus for the aerosol-forming article of claim 2, wherein
the thermistor has a maximum detection temperature of 130° C. or less.

6. The heating apparatus for the aerosol-forming article of claim 2, wherein
the controller uses a clock counter to detect the frequency of the signal output by the oscillator.

7. The heating apparatus for the aerosol-forming article of claim 2, wherein
the oscillator is a voltage-controlled oscillator that outputs a signal with a frequency corresponding to a voltage magnitude of the analog signal output by the temperature sensor.

8. The heating apparatus for the aerosol-forming article of claim 3, wherein
even if a change in the analog signal output by the temperature sensor due to a user's puff falls between as small as 10 mV and 20 mV, the controller can detect a puff.

9. The heating apparatus for the aerosol-forming article of claim 3, wherein
the thermistor has a maximum detection temperature of 130° C. or less.

10. The heating apparatus for the aerosol-forming article of claim 3, wherein
the controller uses a clock counter to detect the frequency of the signal output by the oscillator.

11. The heating apparatus for the aerosol-forming article of claim 3, wherein
the oscillator is a voltage-controlled oscillator that outputs a signal with a frequency corresponding to a voltage magnitude of the analog signal output by the temperature sensor.
